(19) United States
(12) Patent Application Publication
(10) Pub. No.: US 2026/0003657 A1
(43) Pub. Date: Jan. 1, 2026

(54) VIRTUALIZED AND CLOUD AGNOSTIC INDUSTRIAL INTERNET OF THINGS PLATFORM

(71) Applicant: Schlumberger Technology Corporation, Sugar Land, TX (US)

(72) Inventors: Felipe Klein, Houston, TX (US); Puneet Dhaliwal, Houston, TX (US)

(21) Appl. No.: 18/758,476

(22) Filed: Jun. 28, 2024

(51) Int. Cl. G06F 9/455; G16Y 10/25

(52) U.S. Cl. CPC G06F 9/45558; G16Y 10/25; G06F 2009/45595

(57) ABSTRACT

An Industrial Internet of Things (IIoT) edge device includes a memory configured to store first executable code. The IIoT edge device also includes a processor coupled to the memory and configured to execute the first executable code to implement a hypervisor in the IIOT edge device in place of an Operating System (OS) image, virtualize the memory of the IIOT edge device to generate a virtualized memory, and virtualize the processor of the IIoT edge device to generate a virtualized processor. The virtualized processor is configured to execute second executable code to implement a communication protocol in the IIoT edge device to agnostically communicate with an IoT cloud.

### BACKGROUND

The present disclosure generally relates to edge devices in an internet of things platform.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Industrial monitoring and/or control systems have typically been deployed and operated on-site. However, as job sites and operations expand, there has been a continued desire for systems that can be locally deployed while also allowing for remote monitoring, control, updating, etc. One platform that allows for centralized operation is Industrial Internet of Things (IIoT). IIOT provides for connection of devices, sensors, and other industrial equipment to provide remote monitoring, analysis of systems, predictive maintenance, control of equipment/operations, and the like.

Thus, IIoT (or an IIoT platform) can provide remote device monitoring, management, and/or control, application deployment, application monitoring on devices, logistics, and other similar functionalities to industrial facilities or sites. However, there exists challenges in scaling IIoT, preventing it from being generally used without a large amount of resources being expended to tailor the IIoT system or platform to a particular hardware device or cloud provider (public or private). It would be beneficial to address these one or more concerns.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an Industrial Internet of Things (IIoT) system, in accordance with an embodiment;

FIG. 2 illustrates an embodiment of an edge device of the IIOT system of FIG. 1, in accordance with an embodiment; and

FIG. 3 illustrates a flow chart describing implementation and operation of the edge device of FIG. 2, in accordance with an embodiment.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

In an industrial environment, there can include field devices, control systems, monitoring systems, and the like. Typically, these field devices, control systems, monitoring systems, etc. are locally operated, e.g., on site, in their respective industrial environments. However, as cloud computing has grown, the opportunity to control and monitor industrial operations remotely as well as control and monitor industrial operations from multiple sites has grown. One system to allow for remote monitoring and controlling of industrial systems is Industrial Internet of Things (IIoT).

IIOT can allow for local industrial networks to provide access to data from outside the local industrial network. However, one issue with use of IIoT is its general difficulty to comply with client data residency requirements with on-premises or in-country deployments. Another challenge with the use of IIOT is the difficulty in keeping up with the fast pace of hardware improvements. Each new device currently requires a custom operating system image, which is a time-consuming effort that takes away team resources from developing value-adding features.

Embodiments of the present device provide a response to these challenges and focuses on portability both at the cloud and at the edge. On the cloud, services are revamped to use cloud-portable technologies, making the services capable of being deployed anywhere. At the edge, portability is achieved by using virtualization and moving away from the need for custom images. Virtualization is a software abstraction over computer hardware. As described herein, the techniques of virtualization are extended to IIoT edge devices to provide full virtualization at the edge. This allows for support of, for example, heterogeneous workflows including containers, virtual machines, and container orchestration platform that automates the deployment, scaling, and management of containerized applications, e.g., Kubernetes. This allows the infrastructure to be adaptable to a large set of different use cases, making IIoT more readily deployable.

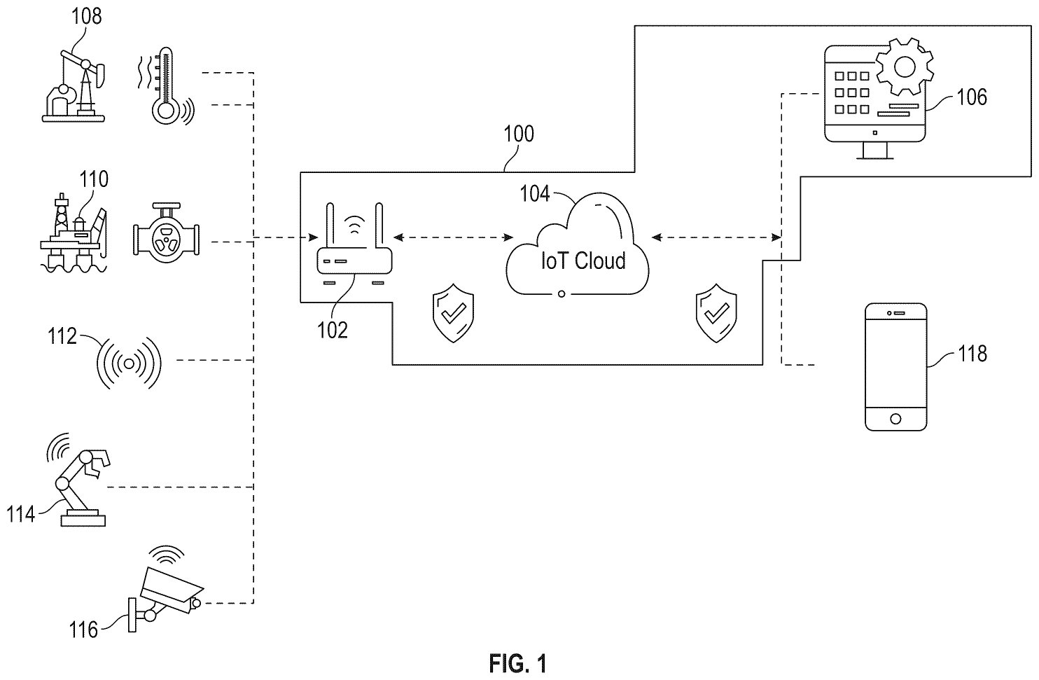

FIG. 1 illustrates an Industrial Internet of Things (IIoT) system 100. As illustrated, the IIoT system 100 includes at least one edge device 102, a cloud 104 (e.g., an IIoT cloud platform), and an edge management device 106. The edge device 102 can be, for example, a gateway, a node, or another network element that allows for transmission of data to and from the cloud 104. One or more edge devices 102 can be locally disposed at an industrial location. For example, natural resource field equipment, such as a pump jack and/or other oil and/or gas equipment, may be located at location 108 (e.g., an industrial location). Sensors, controllers, temperature gauges, and the like (i.e., industrial components) can measure operating properties and implement operations of the natural resource field equipment at location 108. Data collected in connection with the operation of the industrial components can be collected at location 108 and this data can be acquired and aggregated by, for example, an edge device 102 (which may be located at location 108). The data at location 108 can be collected as part of a local network and transmitted (e.g., via a physical connection, such as Ethernet, a direct serial connection, etc. and/or via a wireless connection, such as, Bluetooth, Wi-Fi, or another wireless connection) to the IIoT system 100 via one or more edge devices 102 located at location 108.

Additionally, location 110 (e.g., an industrial location) can be a physically distinct location from location 108, whereby location 110 corresponds to natural resource field equipment, such as a jackup and/or other oil and/or gas equipment. Sensors, controllers, actuators, and the like (i.e., industrial components) can measure operating properties and implement operations of the natural resource field equipment at location 110. Data collected in connection with the operation of the industrial components can be collected at location 110 and this data can be acquired and aggregated by, for example, an edge device 102 (which may be located at location 110). The data at location 110 can be collected as part of a local network and transmitted (e.g., via a physical connection, such as Ethernet, a direct serial connection, etc. and/or via a wireless connection, such as, Bluetooth, Wi-Fi, or another wireless connection) to the IIoT system 100 via one or more edge devices 102 located at location 110.

Location 112, location 114, and location 116 (e.g., respective industrial locations) provide additional examples of physically distinct locations from one another and from location 108 and 110, whereby location 112 includes smart devices utilized in an industrial system, location 114 includes machinery utilized in an industrial system, and location 116 includes Vision and/or IR systems utilized in an industrial system. These respective industrial components at location 112, location 114, and location 116 can measure operating properties and/or implement operations. Data collected in connection with the operation of the industrial components at location 113, location 114, and location 116 can be collected and this data can be acquired and aggregated by, for example, an edge device 102 (which may be located at each of location 112, location 114, and location 116). The data at location 112, location 114, and location 116 can be collected as part of a local network and transmitted (e.g., via a physical connection, such as Ethernet, a direct serial connection, etc. and/or via a wireless connection, such as, Bluetooth, Wi-Fi, or another wireless connection) to the IIoT system 100 via one or more edge devices 102 located respectively at location 112, location 114, and location 116.

In this manner, the respective edge devices 102 operate to provide location information to an external network, the IIOT cloud 104. The IIoT cloud 104 is typically populated with the data from the industrial components (e.g., smart devices) located at locations 108, 110, 112, 114, and 116. In some embodiments, this can be accomplished via, for example, the use of applications to collect data on the respective components that is applied in generating a digital twin of the industrial components at each of locations 108, 110, 112, 114, and 116. The edge device 102, in addition to collecting and transmitting operating data for the locations 108, 110, 112, 114, and 116 also can collect and transmit this industrial component (e.g., smart device) data to the IIOT cloud 104 (i.e., the IIoT cloud computing system). The data transmitted to the IIOT cloud 104 can be encrypted so as to provide security to the transmitted data.

In some embodiments, the IIOT Cloud 104 can be a network of servers and/or web services hosted, for example, on the internet. The IIoT Cloud 104 can operate to store, process, and analyze data received from the one or more edge devices 102. Furthermore, the edge management device 106 may operate to implement edge management, including monitoring, controlling, provisioning, and debugging of one or more edge device 102 and/or the IIoT cloud 104. In some embodiments, the edge management device 106 may include a processing device with at least a processor capable of executing computer-executable code to perform the operations described above. The edge management device 106 can also include memory and/or storage, which may be any suitable articles of manufacture that can serve as media to store processor-executable code, data, or the like. These articles of manufacture may represent computer-readable media (e.g., any suitable form of memory or storage) that may store the processor-executable code used by the processor to perform the above noted techniques.

FIG. 1 additionally illustrates a computing device 118, such as a portable computing device (e.g., a phone, tablet, laptop, or the like) that can be used to access the IIoT cloud via, for example, communication applications, process and safety applications, Application Programming Interfaces (APIs), or the like. The computing device 118 can additionally and/or alternatively include a desktop computer that can be used to access the IIoT cloud via, for example, communication applications, process and safety applications, APIs, or the like. Moreover, the computing device 118 may be utilized to access the information generated by the IIoT could 104 via a secure channel.

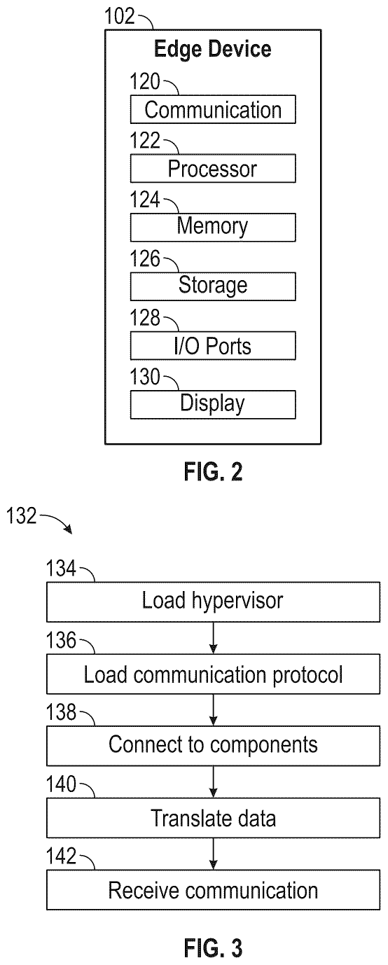

Referring now to FIG. 2, an example of the edge device 102 may include any suitable industrial computing device, or the like and may include various components to perform various analysis operations. As shown in FIG. 2, the edge device 102 may include a communication component 120, a processor 122, a memory 124, a storage component 126, input/output (I/O) ports 128, a display 130, and the like. The communication component 120 may be a wireless or wired communication component that may facilitate communication between different monitoring systems, communication devices, various control systems, and the like. The processor 122 may be any type of computer processor or microprocessor capable of executing computer-executable code. Additionally, the processor 122 may also include multiple processors that may perform the operations described herein. It should also be noted that while processor 122 is illustrated, in some embodiments, additional processing circuitry, for example, accelerators, such as tensor processing units (TPUs) graphics processing units (GPUs) GPU), or other processing circuitry may be present in the edge device 102. In some embodiments, these additional processing circuitry can operate as a processor that performs one or more of the operations described herein, for example, by executing instructions stored in media to perform one or more of the operations described herein.

The memory 124 and the storage component 126 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 122 to perform the presently disclosed techniques. The memory 124 and the storage component 126 may also be used to store data received via the I/O ports 128, data analyzed or transmitted by the processor 122, or the like.

The I/O ports 128 may be interfaces that may couple to various types of I/O modules and/or as an interface to enable the edge device 102 to connect and communicate with surface instrumentation, servers, and the like. It should be noted that the display 130 can be optional and is not present in some embodiments of the edge device 102. However, in embodiments where the display 130 is preset as part of the edge device, the display 130 may include any type of electronic display such as a liquid crystal display, a light-emitting-diode display, and the like. In these embodiments, for example, data acquired via communication component 120 and/or data analyzed by or modified by the processor 122 may be presented on the display 130. Likewise, operational information of the edge device 102 can be presented on the display 130. In certain embodiments, the display 130 may be a touch screen display or any other type of display capable of receiving inputs from an operator. Although the edge device 102 is described as including the components presented in FIG. 2, the edge device 102 should not be limited to including the components listed in FIG. 2. Indeed, the edge device 102 may include additional or fewer components than described above.

It should also be noted that for the sake of modularity and flexibility with regard to both the size and specifications of the targeted facility optimization problem, the edge device 102 may be implemented over a web application with back-end and front-end components. In this scheme, the back-end component may be responsible for handling certain optimization algorithms, while the front-end component may be used to set optimization problem specifications and parameters from a user's perspective as detailed further below. The communication between the front-end component and back-end component of the edge device 102 may involve communications over any suitable network.

In one embodiment, the memory 124 and/or the storage component 126 can store one or more data structures, such as an operating system (OS) image. In such an embodiment, the OS image operates in conjunction with the processor 122 to establish an operating system environment that is suitable for execution of one or more applications, for example, an operating system of an edge gateway device as the edge device 102. With hundreds or more of edge devices 102 disposed in and managed as part of the IIoT system 100, generation of custom OS images can be a time-consuming effort that draws team resources away from other projects, including developing value-adding features.

Additionally, deployment of the edge device 102 can be in locations, for example, with varying client data residency requirements. That is, edge devices 102 may each have differing data requirements set by their on-premises (or in-country) deployments. For example, data residency requirements can affect the effort in porting the IIoT cloud 104 to a suitable cloud provider available in the given country/area/region requested by a customer.

In some embodiments, to address one or more of the items above, in place of the edge device 102 storing and operating using an OS image, the IIoT system 100 leverages virtualization at the edge for the various different edge devices 102 that are supported. This results in a “hardware portable” solution that allows does not require the edge devices 102 to have custom OS images developed for deployment thereon. In operation, in place of the OS image in the edge device 102, a hypervisor is utilized to allow for full virtualization. The hypervisor can be computer readable code that is stored in the memory 124 and/or the storage component 126 and operates in conjunction with the processor 122 to virtualize the edge device 102 (e.g., generate virtualized peripherals, processor 122, memory 124, storage component 126, communication component 120, etc. of the edge device 102).

In some embodiments, the hypervisor utilized in conjunction with the edge devices 102 is a Type 1 hypervisor, which supplants the traditional OS images and runs directly on the hardware of the edge devices 102. The hypervisors provided in the edge devices 102 allow for the creation and management of virtual machines (VMs) and operate to translate requests between physical and virtual resources. In this manner, the hypervisors provide virtualization as a software abstraction over computer hardware (i.e., the hardware of the edge device 102). By applying hypervisors to at each edge device 102, full virtualization at the edge of the IIoT system 100 is accomplished. This virtualization allows for support heterogeneous of workflows including, for example, containers, VMs and Kubernetes, making the infrastructure suitable for a large set of different use cases. This allows the edge devices 102 to be hardware portable (e.g., interchangeable), since they do not require particular OS images to operate and can be deployable in the various locations 108, 110, 112, 114, and 116.

By utilizing a hypervisor, the software stack of the edge device 102 is independent of any operating system. It also allows the edge device to be agnostic as to the type of IIoT cloud 104 that it connects to. That is, the edge device 102 can be reconfigurable for use with different IIOT cloud 104 providers. One technique to allow for the edge devices 102 to be usable with different IIOT cloud 104 is through the use of a predetermined messaging protocol. This predetermined messaging protocol allows for communication between the edge devices 102 and the IIoT cloud 104. For example, the predetermined messaging protocol may be implemented when data is sent to the IIOT cloud 104 from the edge devices 102 and when remote commands are transmitted from the IIOT cloud 104 to the edge devices 102. This predetermined messaging protocol is independent from messaging protocols typically applied by IIOT cloud 104 providers (i.e., the predetermined messaging protocol is not IIOT cloud 104 dependent). Likewise, at the IIOT cloud 104, native technologies are not utilized.

In some embodiments, the messaging protocol can be, for example, Message Queuing Telemetry Transport (MQTT). Likewise, Representational State Transfer (REST or RESTful) Application Programming Interface (API) is an additional protocol that can be employed in addition to and/or in place of MQTT as the messaging protocol utilized for communications in the IIoT system 100.

FIG. 3 illustrates a flow chart 132 describing implementing an edge device 102 in accordance with present embodiments. The blocks of flow chart 132 can be implemented and/or performed by the edge device 102, although it should be understood that the method of flow chart 132 (as well as the techniques previously discussed) may be performed by any suitable computing system, computing device, and/or the like. In this way, it should also be understood that some or all of the below described processing operations may be performed by one or more components of the edge device 102, including the processor 122, the memory 124, or the like, and may be executed by the processor 122, for example, executing code, instructions, commands, or the like stored in the memory 124 and/or the storage component 126 (e.g., a tangible, non-transitory, computer-readable medium).

In block 134, a hypervisor may be loaded onto the edge device 102. The hypervisor may be transmitted from, for example, the IIoT cloud 104 as being sent from edge management device 106. In other embodiments, the hypervisor may be loaded onto the edge device 102, e.g., via the I/O ports 128. The hypervisor can be stored in the memory 124 and/or the storage component 126 and executed by the processor 122 of the edge device in place of an OS image to provide virtualization to the edge device 102 as well as coordinate operation of the edge device. In block 136, the edge device 102 also can operate to load a communication protocol, e.g., from the hypervisor and/or from the IIoT cloud 104 or the edge management device 106. The communication protocol will be utilized to transmit data received from industrial components at a deployed location of the edge device 102 (e.g., location 108) to the IIOT cloud 104 as well as receive communications (e.g., remote commands) from the IIOT cloud 104. It should be noted that blocks 134 and 136 can be performed at a location where the edge device 102 is to be disposed. Alternatively, blocks 134 and 136 can be performed prior to the edge device 102 being implemented at a location where the edge device 102 is to be operated.

In block 138, the edge device 102 is connected to one or more industrial components located at the location (e.g., location 110) where the edge device is deployed. Connecting the edge device 102 to the one or more industrial components allows for the edge device 102 to receive data generated by the one or more industrial components. In block 140, the edge device 102 translates the data into the communication protocol from block 136 for transmission to the IIOT cloud 104, for example, for processing of the data.

In block 142, the edge device receives communications from the IIoT cloud 104. The communications are transmitted using the communication protocol from block 136 and can include, for example, remote commands. Additionally, the communications in block 142 can include, fleet management for the edge devices 102, such as customized applications relevant to the edge device 102 disposed at the particular location (e.g., location 110) and/or general applications usable by more than one of the edge devices 102 in the IIOT system 100.

Technical effect of the disclosed embodiments include customizing edge devices 102 an IIOT system 100 via hypervisors deployed into the edge devices 102. In place of edge device 102 storing and operating using a customized OS image, the IIoT system 100 leverages virtualization via implementation of the hypervisors at the edge for the various different edge devices 102 that are supported. This results in a “hardware portable” solution that allows does not require the edge devices 102 to have custom OS images developed for deployment thereon. Additionally, through the use of prescribed communication protocols, the edge devices 102 are IIoT cloud 104 provider agnostic. Furthermore, particular applications can be directed to and loaded onto respective edge devices 102 of the IIoT system 100 so as to allow for fleet management for the edge devices 102.

The subject matter described in detail above may be defined as set forth below.

A Industrial Internet of Things (IIoT) edge device includes a memory configured to store first executable code; and a processor coupled to the memory and configured to execute the first executable code to implement a hypervisor in the IIoT edge device in place of an Operating System (OS) image, virtualize the memory of the IIoT edge device to generate a virtualized memory, and virtualize the processor of the IIoT edge device to generate a virtualized processor.

The virtualized memory is configured to store a second executable code.

The virtualized processor is configured to execute the second executable code to implement a communication protocol in the IIoT edge device to communicate with an IIoT cloud.

The IIOT device further includes a virtualized communication component coupled to the virtualized processor.

The virtualized communication component is configured to connect to at least one industrial component at a location.

The virtualized communication component is configured to connect to the at least one industrial component via a wireless network or a physical connection.

The virtualized communication component is configured to receive data from the at least one industrial component via the wireless network or the physical connection.

The virtualized processor is configured to transmit the data to the IIOT cloud utilizing the communication protocol.

The virtualized processor is configured to receive an application from the IIoT cloud and store the application in the virtualized memory for execution.

A memory includes instructions configured to cause a processor of an Industrial Internet of Things (IIoT) edge device to execute first executable code stored in the memory the IIoT edge device to implement a hypervisor in the IIoT edge device in place of an Operating System (OS) image, virtualize the memory of the IIoT edge device to generate a virtualized memory, and virtualize the processor of the IIoT edge device to generate a virtualized processor.

The instructions cause the virtualized processor of the IIoT edge device to execute second executable code stored in virtual memory to implement a communication protocol in the IIoT edge device to communicate with an IIOT cloud.

The instructions cause the virtualized processor of the IIoT edge device to connect a virtualized communication component to at least one industrial component at a location to receive data from the at least one industrial component.

The instructions cause the virtualized processor of the IIoT edge device to connect the virtualized communication component to the at least one industrial component via a wireless network.

The instructions cause the virtualized processor of the IIoT edge device to initiate transmission of data received from the at least one industrial component to the IIOT cloud utilizing the communication protocol.

The instructions cause the virtualized processor of the IIOT edge device to receive an application from the IIOT cloud and store the application in the virtualized memory for execution.

A method includes storing first executable code in a memory of an Internet of Things (IIoT) edge device; and executing the first executable code via a processor coupled to the memory to implement a hypervisor in the IIOT edge device in place of an Operating System (OS) image, virtualize the memory of the IIoT edge device to generate a virtualized memory, and virtualize the processor of the IIoT edge device to generate a virtualized processor.

The method further includes storing a second executable code in the virtualized memory; and executing the second executable code via the virtualized memory to implement a communication protocol in the IIOT edge device to communicate with an IIOT cloud.

The method further includes connecting a virtualized communication component of the IIoT edge device to at least one industrial component at a location to receive data from the at least one industrial component.

The method further includes transmitting the data via the virtualized communication component to the IIoT cloud utilizing the communication protocol.

The method further includes receiving an application from the IIoT cloud and storing the application in the virtualized memory for execution by the virtualized processor.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical.

1. An Industrial Internet of Things (IIoT) edge device, comprising:
a memory configured to store first executable code; and
a processor coupled to the memory and configured to:
execute the first executable code to implement a hypervisor in the IIoT edge device in place of an Operating System (OS) image;
virtualize the memory of the IIoT edge device to generate a virtualized memory; and
virtualize the processor of the IIoT edge device to generate a virtualized processor.

2. The IIoT edge device of claim 1, wherein the virtualized memory is configured to store a second executable code.

3. The IIoT edge device of claim 2, wherein the virtualized processor is configured to execute the second executable code to implement a communication protocol in the IIoT edge device to communicate with an IIoT cloud.

4. The IIoT edge device of claim 3, further comprising a virtualized communication component coupled to the virtualized processor.

5. The IIoT edge device of claim 4, wherein the virtualized communication component is configured to connect to at least one industrial component at a location.

6. The IIoT edge device of claim 5, wherein the virtualized communication component is configured to connect to the at least one industrial component via a wireless network or a physical connection.

7. The IIoT edge device of claim 6, wherein the virtualized communication component is configured to receive data from the at least one industrial component via the wireless network or the physical connection.

8. The IIoT edge device of claim 7, wherein the virtualized processor is configured to transmit the data to the IIOT cloud utilizing the communication protocol.

9. The IIoT edge device of claim 5, wherein the virtualized processor is configured to receive an application from the IIoT cloud and store the application in the virtualized memory for execution.

10. A memory, comprising instructions configured to cause a processor of an Industrial Internet of Things (IIoT) edge device to:
execute first executable code stored in the memory the IIoT edge device to:
implement a hypervisor in the IIoT edge device in place of an Operating System (OS) image;
virtualize the memory of the IIoT edge device to generate a virtualized memory; and
virtualize the processor of the IIoT edge device to generate a virtualized processor.

11. The memory, of claim 10, wherein the instructions cause the virtualized processor of the IIoT edge device to execute second executable code stored in virtual memory to implement a communication protocol in the IIoT edge device to communicate with an IIoT cloud.

12. The memory, of claim 11, wherein the instructions cause the virtualized processor of the IIoT edge device to connect a virtualized communication component to at least one industrial component at a location to receive data from the at least one industrial component.

13. The memory of claim 12, wherein the instructions cause the virtualized processor of the IIoT edge device to connect the virtualized communication component to the at least one industrial component via a wireless network.

14. The memory of claim 12, wherein the instructions cause the virtualized processor of the IIoT edge device to initiate transmission of data received from the at least one industrial component to the IIoT cloud utilizing the communication protocol.

15. The memory of claim 11, wherein the instructions cause the virtualized processor of the IIoT edge device to receive an application from the IIoT cloud and store the application in the virtualized memory for execution.

16. A method, comprising:
storing first executable code in a memory of an Internet of Things (IIoT) edge device; and
executing the first executable code via a processor coupled to the memory to:
implement a hypervisor in the IIoT edge device in place of an Operating System (OS) image;
virtualize the memory of the IIoT edge device to generate a virtualized memory; and
virtualize the processor of the IIoT edge device to generate a virtualized processor.

17. The method of claim 16, further comprising:
storing a second executable code in the virtualized memory; and
executing the second executable code via the virtualized memory to implement a communication protocol in the IIoT edge device to communicate with an IIOT cloud.

18. The method of claim 17, further comprising connecting a virtualized communication component of the IIoT edge device to at least one industrial component at a location to receive data from the at least one industrial component.

19. The method of claim 18, further comprising transmitting the data via the virtualized communication component to the IIoT cloud utilizing the communication protocol.

20. The method of claim 17, further comprising receiving an application from the IIoT cloud and storing the application in the virtualized memory for execution by the virtualized processor.
